(19) United States
(12) Patent Application Publication
(10) Pub. No.: US 2016/0112707 A1
(43) Pub. Date: Apr. 21, 2016

(54) POLICY-BASED IMAGE ENCODING

(71) Applicant: Intel Corporation, Santa Clara, CA (US)

(72) Inventors: Paul S. Diefenbaugh, Portland, OR (US); Yiting Liao, Hillsboro, OR (US); Steven B. McGowan, Portland, OR (US); Vallabhajosyula S. Somayazulu, Portland, OR (US); Nithyananda S. Jeganathan, Portland, OR (US); Barry A. O'Mahony, Banks, OR (US); Kristoffer D. Fleming, Chandler, AZ (US)

(73) Assignee: Intel Corporation, Santa Clara, CA (US)

(21) Appl. No.: 14/515,175

(22) Filed: Oct. 15, 2014

(51) Int. Cl. H04N 19/136; G09G 5/00; H04N 19/17; H04N 19/50

(52) U.S. Cl. CPC H04N 19/136; H04N 19/50; G09G 5/003; H04N 19/17

(57) ABSTRACT

Techniques for image rendering are described herein. The techniques may include providing image data to an encoder for transmission to a display. An indication of whether at least a portion of the image data is video data or non-video data is provided. A first policy may be implemented for image data that is video data. The first policy prioritizes transmission of the image data over encoding image quality. A second policy may be implemented for image data that is non-video data. The second policy prioritizes encoded image quality over transmission of the encoded images.

### TECHNICAL FIELD

This disclosure relates generally to image encoding. More specifically, the disclosure describes image encoding using a policy based approach.

### BACKGROUND

Computing devices increasingly are being used to view images on a display device associated with the computing device. For example, image data may be rendered by a graphics processing unit, or in cooperation with an operating system to be displayed at a wireless display device. In some scenarios, image data is packetized by a display system having an encoder to be provided to an external display device. Some examples of packetized display systems may include wireless display systems wherein a computing device may provide image data to an external display via a wireless communication protocol such as Wireless Fidelity (WiFi), Wireless Gigabit (WiGig), and the like. Other packetized display systems may include Universal Serial Bus (USB) protocol display systems. Where large amounts of data must be transmitted to a display device, the time to transmit that data and the load placed on the system increases, creating inefficiencies in the use of the system equipment and the use of available bandwidth.

### BRIEF DESCRIPTION OF DRAWINGS

FIG. 1 is a block diagram of a computing device having a policy based display encoding system;

FIG. 2 is process flow diagram illustrating a policy process applied to video data;

FIG. 3 is process flow diagram illustrating a policy process using intraframe (I-Frame) or predictive frame (P-Frame) technology;

FIG. 4 is process flow diagram illustrating a policy process having progressive transmission;

FIG. 5 is a diagram illustrating multi-region updates;

FIG. 6 is a diagram illustrating monitoring image quality of encoded updates;

FIG. 7 is a flow diagram illustrating functional components of the policy based image encoding;

FIG. 8 is a block diagram illustrating a method of policy-based image encoding; and

FIG. 9 is a block diagram depicting an example of a computer-readable medium configured to implement policy-based image encoding.

### DETAILED DESCRIPTION

The subject matter disclosed herein relates to techniques for image encoding using a policy based approach. As discussed above, packetized display systems may encode and transmit image data to a display device. In many cases, bandwidth may be limited, and therefore, large amounts of data to be transmitted may increase the latency of transmission as well as increase power consumption as result of increased load. The techniques described herein include a policy based approach to encoding and transmitting image data to a display. A first policy may favor low latency transmission over higher image quality when the data to be transmitted is video data, or in other words, data that is changing frequently. A second policy may favor higher image quality data over low latency when the data to be transmitted is non-video data, or in other words, when the data is not changing frequently.

The terms “low latency” and “frequently,” may be relative terms. However, the term “low latency,” as referred to herein is a low transmission time in comparison to a latency that would otherwise be higher if image quality is favored for a given image data type, i.e., video data, that is frequently changing. For example, if image quality was prioritized over latency time for video data, the time between successive encoded and transmitted frames may increase. Therefore, the term low latency may be understood as a comparison to the latency that would otherwise be required if image quality was prioritized or required to be at a certain threshold. In some cases, the term “low latency” may be based on a predetermined threshold value indicating a time period below which the latency of transmission is considered low.

The term “frequently” as referred to herein, may refer to a threshold change rate, above which the image data may be considered high. In some cases, the term “frequently” may be determined by a type of data being transmitted. For example, image data that is video data may be categorized as frequently changing image data whether or not the change rate meets or exceeds the threshold discussed above. Video data, as referred to herein, may include natural video data associated with data that is frequently changing above a given threshold. In contrast, non-video data may include data that is below the given threshold, and may include data that is associated with changes in productivity graphics. For example, changes to a word processor application may be relatively infrequent when compared to video data. Changes to image data associated with a word processor application may be one of example changes occurring in productivity graphics. Other examples of changes in productivity graphics may include changes occurring in a file window application, a presentation application, a document viewer application, and the like.

A user may view lower image quality in a video with less scrutiny than, lower image quality in static, or non-video, image data. For example, since the content of each frame of video data may be changing with each successive frame, the policy based encoding may provide encoded frames quickly, in comparison to a latency that may occur if image quality were required to remain at a set threshold. In contrast, since each frame of non-video data, such a frame including a word processor document to be displayed is not frequently changing, the policy based encoding may favor image quality over low latency. In this case, objects displayed within the word processor document image may be presented with high image quality, even at the expense of a higher latency. However, because changes are occurring infrequently in the word processor document image, the image is likely to be encoded and transmitted to the display device with a latency that is still relatively low in comparison to the video image data wherein low latency is favored.

In any case, the techniques described herein include a policy based encoding system wherein prioritizations may change based on the type of image data to be encoded, or the frequency of change of the image data to be encoded. Other embodiments, discussed in more detail below include selectively updating a portion of a frame, progressively updating a frame or a portion of the frame, multi-region updates, quality indicator tracking, progress indication tracking, distributed feedback, distributed control, and the like.

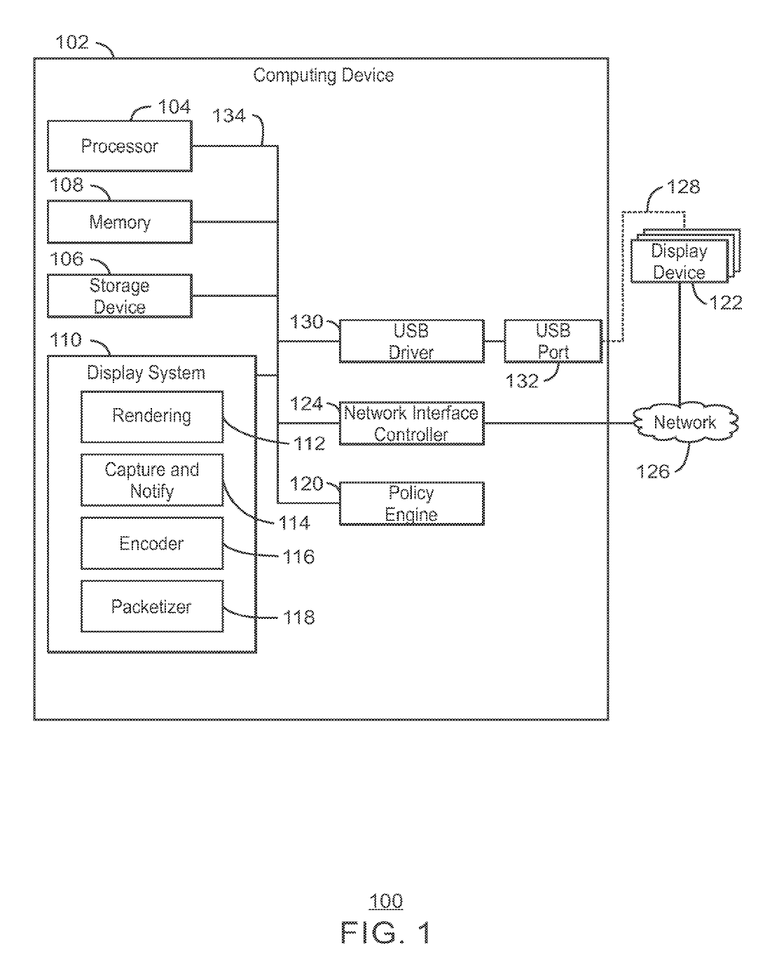

FIG. 1 is a block diagram of a computing device having a policy based display encoding system. The computing device 102 may include a processor 104, a storage device 106 including a non-transitory computer-readable medium, and a memory device 108. The computing device 102 may include a display system 110 configured to implement policy decisions at components associated with image display, such as rendering module 112, a capture and notify module 114, an encoder 116, a packetizer 118, and the like. A policy engine 120 may be referenced by the display system 110 during implementation of a given policy. The policy engine 120 may be a policy architecture wherein packetized data streams may be encoded differently depending on characteristics of the image data in order to preserve energy, increase image quality, lower latency, and the like. In some cases, the policy engine may be configured to be stored on the storage device 106 and be referenced by the display system 110 via the processor 104. In any case, the display system is configured to encode and transmit image data to one or more external display devices 122.

The display devices 122 may be communicatively coupled to the computing device 102 via a wireless connection through a network interface controller (NIC) 124, and a network 126. In some cases, the techniques discussed herein may be implemented in a wired communication as indicated by the dashed line 128, wherein image data is provided to external display devices 122 via a Universal Serial Bus (USB) driver 130 and a USB port 132

In embodiments, the elements of the display system 110 may be implemented as logic, hardware logic, or software configured to be carried out by the processing device 104. In yet other examples, the elements of the display system 110 may be a combination of hardware, software, and firmware. The elements of the display system 110 may be configured to operate independently, in parallel, distributed, or as a part of a broader process. The elements of the display system 110 may be considered separate modules or sub-modules of a parent module. Additional modules may also be included.

In some cases, elements of the display system 110 may be implemented in other elements of the computing device 102. For example, the rendering module 112 may be implemented within an operating system of the computing device, and is configured to render image data for encoding. Likewise, the capture and notify module 114 may be implemented within the operating system, or may be a part of a graphics stack configured to identify when the image data is video data or non-video data and notify the encoder 116. This a priori knowledge of video vs. non-video data may be used by the encoder to encode the image data according to one or more policies.

As discussed above, the policies may include a first policy wherein the encoder 116 is to prioritize transmission, i.e., low latency, over encoded image quality for image data that is video data. In other words, the first policy may transmit image data that is changing frequently within available bandwidth constraints of a transmission link at the expense of potentially lower image quality. In a second policy, the encoder 116 is to prioritize image quality over low latency for non-video data. In other words, the second policy will hold off on transmitting until a certain level of image quality is met, or seek to transmit at a higher bandwidth than instantaneously available, thereby sacrificing low latency for image quality for image data that is not frequently changing. Other policies may be implemented, however, the first and second policy are implemented to provide high image quality to a user for image data that is not frequently changing such as image data of a word processor document, and low latency for image data that is frequently changing such as a video. After the encoder 116 encodes the image data, the packetizer 118 may packetize the image data for transmission to one or more of the external display devices.

The processor 104 may be a main processor that is adapted to execute the stored instructions. The processor 104 may be a single core processor, a multi-core processor, a computing cluster, or any number of other configurations. The processor 104 may be implemented as Complex Instruction Set Computer (CISC) or Reduced Instruction Set Computer (RISC) processors, x86 Instruction set compatible processors, multi-core, or any other microprocessor or central processing unit (CPU).

The memory device 108 can include random access memory (RAM) (e.g., static random access memory (SRAM), dynamic random access memory (DRAM), zero capacitor RAM, Silicon-Oxide-Nitride-Oxide-Silicon SONOS, embedded DRAM, extended data out RAM, double data rate (DDR) RAM, resistive random access memory (RRAM), parameter random access memory (PRAM), etc.), read only memory (ROM) (e.g., Mask ROM, programmable read only memory (PROM), erasable programmable read only memory (EPROM), electrically erasable programmable read only memory (EEPROM), etc.), flash memory, or any other suitable memory systems. The main processor 104 may be connected through a system bus 134 (e.g., Peripheral Component Interconnect (PCI), Industry Standard Architecture (ISA), PCI-Express, HyperTransport®, NuBus, etc.) to components including the memory 108 and the storage device 106.

The block diagram of FIG. 1 is not intended to indicate that the computing device 102 is to include all of the components shown in FIG. 1. Further, the computing device 102 may include any number of additional components not shown in FIG. 1, depending on the details of the specific implementation.

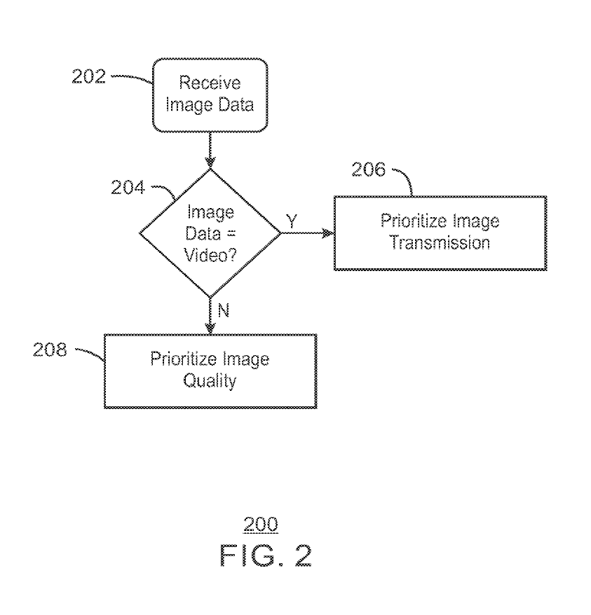

FIG. 2 is process flow diagram illustrating a policy process applied to video data. As discussed above in regard to FIG. 2, the first policy is configured to prioritize image transmission for image data that is video data. For example, at 202 image data may be received. The image data may be received by an operating system. At 204, a determination is made as to whether the image data is video or non-video. The determination may be made by one or more of the operating system, a graphics stack, and the like. In any case, the determination is made a priori to providing the image data and the indication of image data type to an encoder. A priori determination discussed above offloads image data type determination from the encoder and allows a component having more processing power, such as the graphics stack, the operating system, and the like to perform the determination.

In embodiments, the image data is determined to be video or non-video by a determination of frequency of changes within the image data. For example, the rate of change of the image data may be compared to a predetermined threshold. Image data that is above the threshold may be classified as video data, while image data that is below the threshold may be classified as non-video data.

At block 206, if the image data is video data, the encoder 116 of FIG. 1 will prioritize image transmission, and may potentially allow image quality to decrease. At block 208, if the image data is non-video data, the encoder 116 prioritizes image quality, and may potentially allow latency of transmission to increase.

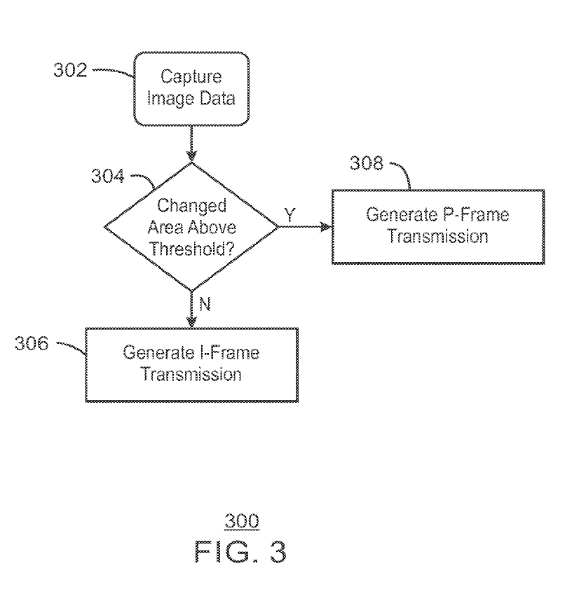

FIG. 3 is process flow diagram illustrating a policy process using intraframe (I-Frame) or predictive frame (P-Frame) technology. In some cases, the first or second policy may be implemented differently based on whether a detected change occurs in a small enough portion of an area to be displayed. As illustrated in FIG. 3, image data is received at 302 indicating a change in the image data from a previously transmitted frame, and a determination is made as to whether the changed area is above a predetermined threshold at 304.

For example, image data may indicate a change in only a 20% portion of the total display frame. If the change affects only a small percentage of the total display frame, the first policy, wherein image quality is prioritized over low latency transmission. In FIG. 3, an intraframe (i-Frame) may be generated for transmission if the portion is below the predetermined threshold as indicated at 306. An i-Frame transmission may provide a higher quality image to be displayed than a p-frame encoded transmission generated at 308. While an i-Frame transmission may be typically a high bandwidth transmission, if only a small portion of the image data has changed, the bandwidth will be relatively small. Therefore, the policy illustrated in FIG. 3 may take advantage of higher quality updates that may be transmitted quickly even in view of bandwidth constraints. Further, because only a small change has occurred, transmitting an i-Frame may reduce the computational load of the encoder 116 of FIG. 1 since a p-Frame encoding requires referencing previous frames to determine an accurate p-Frame encoded transmission.

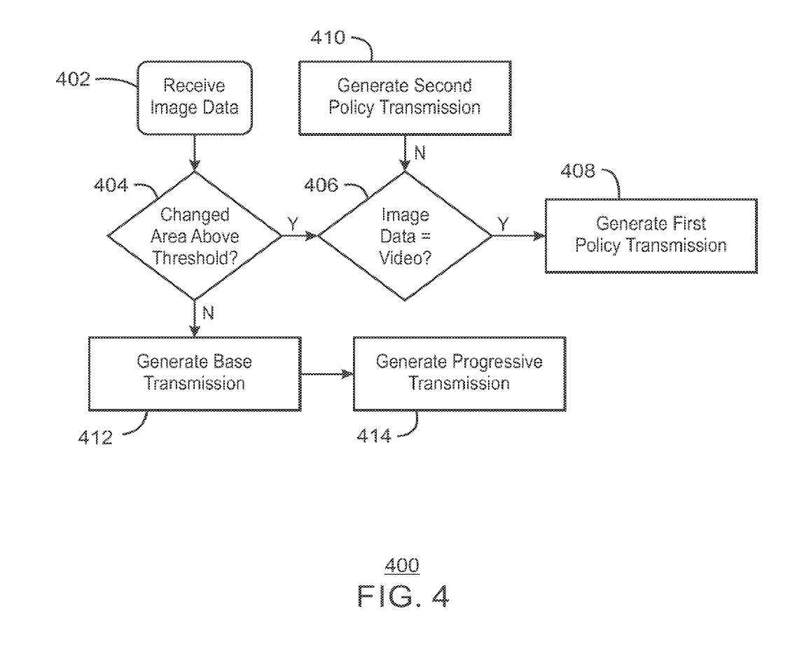

FIG. 4 is process flow diagram illustrating a policy process having progressive transmission. As discussed above in regard to FIG. 3, in some cases, the first or second policy may be implemented differently based on whether a detected change occurs in a small enough portion of an area to be displayed. As illustrated in FIG. 4, image data is received at 402, and a determination of whether changed image data is above an area threshold at 404. If the area is above the threshold, and it is determined that the image data is video data at 406, the image data is encoded and transmitted according to the first policy discussed above in regard to FIG. 1 and FIG. 2, and as indicated at 408. If the image data is not video, but still above the changed area threshold, the image data is encoded and transmitted according to the second policy transmission as indicated at 410.

If the changed area is not above the threshold, then a base transmission may be generated employing the second policy prioritizing image quality over low latency, as indicated at 412. In some cases, the base transmission may achieve a desired image quality. However, if the base transmission does not achieve the desired image quality, progressive updates may be encoded and transmitted until the desired image quality is achieved, as indicated at 414. In some cases, desired quality may be associated with a predetermined value, and the quality of any given image may be tracked as image data is encoded and transmitted. A quality indicator, as discussed in more detail below, may be used to track quality of an image that has been encoded and transmitted.

The base transmission and the progressive updates may be encoded using Scalable Video Coding (SVC). For example, as a region becomes static, SVC fidelity enhancement layers may be use provide progressive updates. Additionally or alternatively, in some case, the base transmission and the progressive updates may be encoded using Advanced Video Codec (AVC) using corresponding frame-level refinements.

As discussed above, updates may be the result of only a portion of a currently displayed image having changed. The changed portion may be referred to herein as a changed “region.” Selective region updates discussed above may be tracked by logic, such as the display system 110 of FIG. 1.

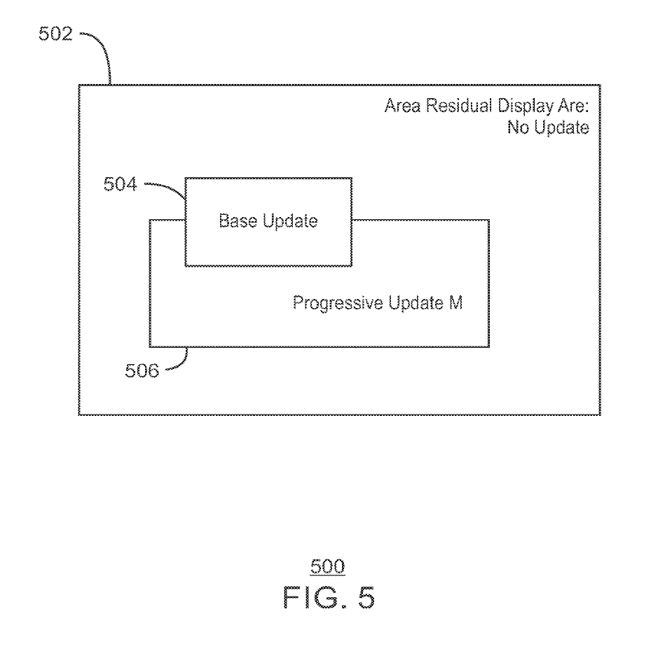

FIG. 5 is a diagram illustrating multi-region updates. The techniques described herein include updating multiple regions via SVC layers or AVC frames. Regions may, by definition, require different types of updates, or no update at all if image data associated with a given region has not changed.

As illustrated in FIG. 5, a display 500 may include three regions including region 502, region 504, and region 506. Region 502 may be a residual display area, and regions 504 and 506 may require image data updates. As indicated in FIG. 5, region 504 may be provided a base update, while region 506 is provided a progressive update. The progressive update for region 506 and the base update for region 504 may be multiplexed for transmission as a result of changed occurring during a previous frame time. Knowledge and tracking of selective and multi-region updates over time enables the encoder 116 of FIG. 1 to perform region-specific updates. Further, region specific knowledge and tracking may also be implemented by the display system 110 of FIG. 1 to determine whether a region has not changed, and therefore the encoder 116 may disable motion search for the unchanged region, and employ a skip mode for macro-blocks associated with the unchanged region.

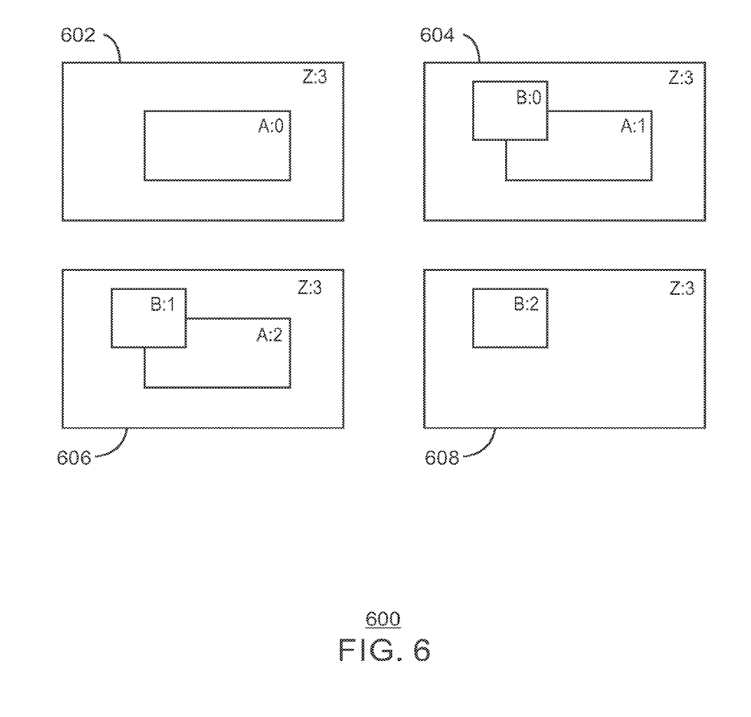

FIG. 6 is a diagram illustrating monitoring image quality of encoded updates. As discussed above, logic, such as the display system 110 of FIG. 1 may be configured to track updates for regions including a set of macro-blocks, scan lines, and the like. The encoder 116 of FIG. 1 may be further configured to track temporal and spatial characteristics of regions and their associated updates. An update may generally begin when a change to a region of the displayed image is detected and becomes active content. An update may end when a change to region of the displayed image ends and becomes static content, or when the region has achieved a target image quality.

The techniques described herein include meta-data used to track image quality and progress of image data and associated updates. FIG. 6 illustrates four stages including stage 602, stage 604, stage 606, and stage 608, as an example of regions within a given display area that receive updates and wherein the image quality of any given region is tracked. For example, at stage 602, region A has an image quality value of 0, while region Z has an image quality value of 3. In this example, an image quality value of 3 is the target image quality value wherein the encoder may determine that no further updates are required. In a subsequent stage, such as stage 604, region A has a value of 1, region Z continues to have a value of 3, and a new region—region B—has a value of 0. Further stages 606 and 608 illustrate that regions A, B, and Z are monitored until the target value of 3 is achieved for each region.

In some cases, an image quality value of zero may indicate that the content of a given region has recently changed per a selective update discussed above in regard to FIGS. 2, 3, and 4. An image quality value of 1 may be a base update and a value of 2 or higher may indicate the number of progressive updates that have been encoded by the encoder 116.

In embodiments, SVC may be used to enable a finer granularity. Specifically, a base update may include multiple progressive updates within each frame time. Note that in FIG. 6, no updates are encoded, packetized, or transmitted for a background region, such as region Z, which represents all regions residing at the given target quality level of 3.

In embodiments, meta-data may be gathered by the display system 110 to track when each region has been encoded, packetized, transmitted, and the like to improve robustness and debug-ability of the display system 116. Specifically, meta-data indicating the progress of any given update may be tracked. For example, a failure to packetize or transmit an encoded update in a given frame may be detected and handled at the encoder 116 at the start of the next frame. In the context of SVC, this may apply at both sub-frame and frame boundaries.

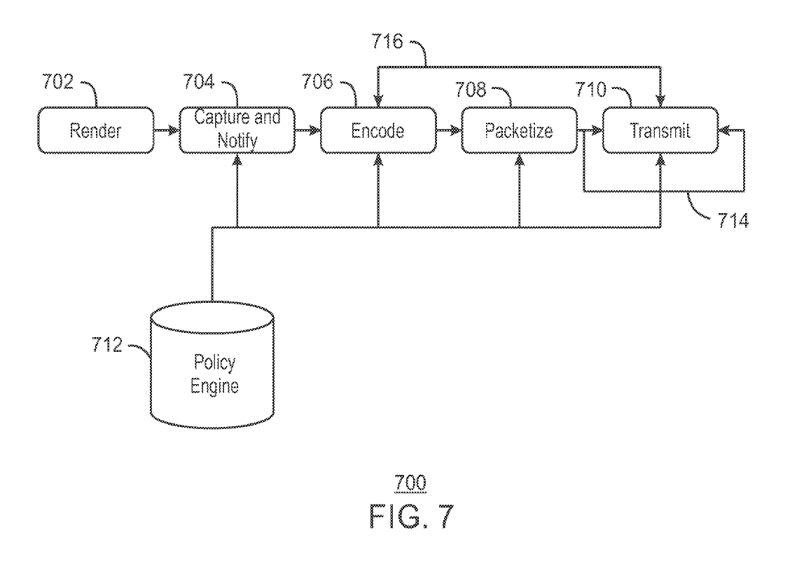

FIG. 7 is a flow diagram illustrating functional components of the policy based image encoding. A display system, such as the display system 110 of FIG. 1, may implement an image data encode and transmit pipeline. As indicated in FIG. 7, image data may be encoded at 702. Image data that is changing, or is otherwise indicated as video data, is captured at 704 and the encoder 116 is notified, prior to the image data being encoded at 706. The encoded image data is packetized at 708 and transmitted at 710. The policy engine 712 may be used by the display system 110 as progress and image quality data is monitored to implement policies, such as the first and second policy discussed above.

In addition, the display system 110 may be configured to enable localized control at each functional block and the associated component, as indicated at 714. For example, the transmit block 710 may be associated with a NIC, such as the NIC 124, configured to transmit encoded and packetized image data updates. A thermal constraint leveraged on the NIC 124 may result in the NIC 124 dropping progressive updates from a transmit bit-stream to reduce wireless transmission bandwidth. The NIC 124 may be configured to choose which packets to drop based on overall system goals associated with the policy engine 712.

In some cases, localized control may be implemented via prioritization among updates. For example, a base update may be prioritized over progressive updates both within frame/layer in a multi-region update, and across frames/layers whenever the system is constrained to ensure low latency and smoothness at the expense of higher fidelity for static regions. In this scenario, the encoder 116 is configured to encapsulate and flag regions of different update types. Downstream components, such as the packetizer 118, and the NIC 124, may be configured to identify and parse flagged regions, and perform localized actions, such as packet dropping, based on the flagged regions.

Further, feedback may be provided between functional component blocks. For example, the NIC 124 may be constrained by a thermal condition preventing transmission of the packetized updates. If the condition persists beyond a configurable time period, the NIC 124 may notify the encoder 116, as indicated at 716. The notification may indicate that progressive updates will be dropped to avoid unnecessary encoding and packetization of subsequent progressive updates.

In general, the display system 110 may be configured to ascertain a net impact of a given constraint, such as a power consumption impact from the given constraint, a thermal impact, a bandwidth impact, and the like. For example, a sustained drop in wireless bandwidth may negatively impact user-perceived quality wherein progressive updates are dropped. Feedback from the NIC 124 to the encoder 116 may avoid generating progressive updates as discussed above. A more integrated approach may also be implemented wherein a constraint is detected and the encoder 116 is tuned accordingly. For example, the encoder 116 may be configured to generate smaller but relatively more progressive updates during the sustained drop in bandwidth than would otherwise occur.

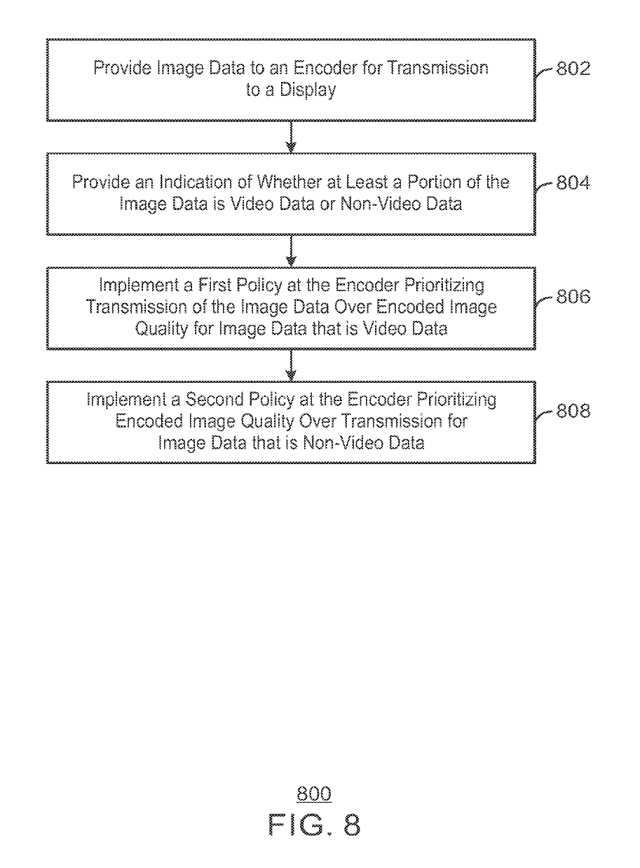

FIG. 8 is a block diagram illustrating a method of policy-based image encoding. At 802, image data is provided to an encoder for transmission to a display. An indication is provided of whether at least a portion of the image data is video data or non-video data at block 804. A first policy is implemented at the encoder prioritizing low latency transmission of the image data over encoded image quality for image data that is video data, as indicated at block 806. At block 808, a second policy may be implemented at the encoder for non-video data, wherein the second policy prioritizes encoded image quality over low latency transmission.

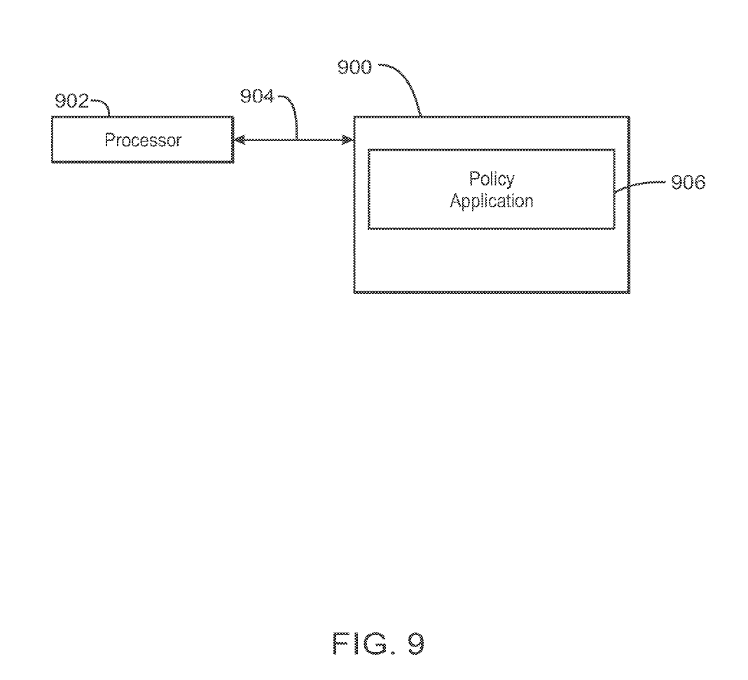

FIG. 9 is a block diagram depicting an example of a computer-readable medium configured to implement policy-based image encoding. The computer-readable medium 900 may be accessed by a processor 902 over a computer bus 904. In some examples, the computer-readable medium 900 may be a non-transitory computer-readable medium. In some examples, the computer-readable medium may be a storage medium, but not including carrier waves, signals, and the like. Furthermore, the computer-readable medium 900 may include computer-executable instructions to direct the processor 902 to perform the steps of the current method.

The various software components discussed herein may be stored on the tangible, non-transitory, computer-readable medium 900, as indicated in FIG. 9. For example, a policy application 906 may be configured to provide image data to an encoder for transmission to a display, and provide an indication of whether at least a portion of the image data is video data or non-video data. The policy application 906 may also be configured to implement a first policy at the encoder prioritizing transmission of the image data over encoded image quality for image data that is non-video data, and implement a second policy at the encoder prioritizing encoded image quality over transmission for image data that is non-video data.

Examples may include subject matter such as a method, means for performing acts of the method, at least one machine-readable medium including instructions that, when performed by a machine cause the machine to performs acts of the method.

Example 1 includes a system for policy based display encoding. The system includes logic, at least partially including hardware logic, to provide image data to an encoder for transmission to a display and to provide an indication of whether at least a portion of the image data is video data or non-video data. The logic is further configured to implement a first policy at the encoder prioritizing transmission of the image data over encoded image quality for image data that is video data and to implement a second policy at the encoder prioritizing encoded image quality over transmission for image data that is non-video data.

Example 2 includes a method for policy based display encoding. The method includes providing image data to an encoder for transmission to a display and providing an indication of whether at least a portion of the image data is video data or non-video data. The method includes implementing a first policy at the encoder prioritizing transmission of the image data over encoded image quality for image data that is video data and implementing a second policy at the encoder prioritizing encoded image quality over transmission for image data that is non-video data. In some cases, a computer readable medium may be implemented to carry out the method of Example 2.

Example 3 includes computer readable medium including code, when executed, to cause a processing device to provide image data to an encoder for transmission to a display. The code may also be implemented to provide an indication of whether at least a portion of the image data is video data or non-video data and implement a first policy at the encoder prioritizing transmission of the image data over encoded image quality for image data that is non-video data. The code may further be configured to implement a second policy at the encoder prioritizing encoded image quality over transmission for image data that is non-video data.

Example 4 includes an apparatus comprising a means for implementing image policies. The means is to provide image data to an encoder for transmission to a display, and provide an indication of whether at least a portion of the image data is video data or non-video data. The means is further configured to implement a first policy at the encoder prioritizing transmission of the image data over encoded image quality for image data that is non-video data and implement a second policy at the encoder prioritizing encoded image quality over transmission for image data that is non-video data.

Example 5 includes apparatus comprising logic, at least partially comprising hardware logic for implementing image policies. The logic is to provide image data to an encoder for transmission to a display and provide an indication of whether at least a portion of the image data is video data or non-video data. The logic is further configured to implement a first policy at the encoder prioritizing transmission of the image data over encoded image quality for image data that is non-video data and implement a second policy at the encoder prioritizing encoded image quality over transmission for image data that is non-video data.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A system for policy based display encoding, comprising logic at least partially comprising hardware logic, to:
provide image data to an encoder for transmission to a display;
provide an indication of whether at least a portion of the image data is video data or non-video data;
implement a first policy at the encoder prioritizing transmission of the image data over encoded image quality for image data that is video data; and
implement a second policy at the encoder prioritizing encoded image quality over transmission for image data that is non-video data.

2. The system of claim 1, wherein the indication is provided from one or more of:
an operating system associated with the system for policy based image encoding;
a graphics stack of the system associated with the system for policy based image encoding; or
any combination thereof.

3. The system of claim 1, wherein at least a portion of the logic is implemented at the encoder, wherein the encoder logic is to implement the second policy when the portion of the image data is below a threshold of a total display area at which the image data is to be displayed.

4. The system of claim 3, wherein the encoder logic is to implement the second policy by generating an intraframe (i-Frame) for transmission as opposed to an predictive frame (p-Frame) as long as the portion of the image data is below the threshold.

5. The system of claim 3, wherein the encoder logic is to implement the second policy by providing an initial update having a maximum image quality in view of system constraints imposing a limit on maximum image quality encoding.

6. The system of claim 5, wherein the encoder logic is to incrementally update encoded image quality until one or more of:
a target quality is achieved;
a change to the displayed image continues to occur before the target quality is achieved; and
system constraints impose a limit on subsequent updates.

7. The system of claim 6, wherein the encoder logic is to provide image quality updates for a plurality of regions concurrently.

8. The system of claim 1, wherein at least a portion of the logic is implemented at the encoder, wherein the encoder logic is to:
track a quality indication achieved for a given portion of the image data to be displayed;
track a progress indication achieved for the given portion of the image.

9. The system of claim 1, wherein the logic is to:
receive feedback from components downstream from the encoder indicating whether an image quality update is to be dropped by a downstream component;
implement additional policies at downstream components based on factors comprising:
the first and second policies;
system constraints;
the feedback from downstream components; or
any combination thereof.

10. The system of claim 1, wherein at least a portion of the logic is implemented at the encoder, wherein the encoder logic is to flag encoded data based on a prioritization to be readable by downstream components.

11. A method for policy based display encoding, the method comprising:
providing image data to an encoder for transmission to a display;
providing an indication of whether at least a portion of the image data is video data or non-video data;
implementing a first policy at the encoder prioritizing transmission of the image data over encoded image quality for image data that is video data; and
implementing a second policy at the encoder prioritizing encoded image quality over transmission for image data that is non-video data.

12. The method of claim 11, wherein the indication is provided from one or more of:
an operating system associated with the system for policy based image encoding;
a graphics stack of the system associated with the system for policy based image encoding; or
any combination thereof.

13. The method of claim 11, further comprising implementing the second policy when the portion of the image data is below a threshold of a total display area at which the image data is to be displayed.

14. The method of claim 13, further comprising implementing the second policy by generating an intraframe (i-Frame) for transmission as opposed to a predictive frame (p-Frame) as long as the portion of the image data is below the threshold.

15. The method of claim 13, further comprising implementing the second policy by providing an initial update having a maximum image quality in view of system constraints imposing a limit on maximum image quality encoding.

16. The method of claim 15, further comprising incrementally updating the encoded image quality until one or more of:
a target quality is achieved;
a change to the displayed image continues to occur before the target quality is achieved; and
system constraints impose a limit on subsequent updates.

17. The method of claim 16, further comprising providing image quality updates to a plurality of regions concurrently.

18. The method of claim 11, further comprising:
tracking a quality indication achieved for a given portion of the image data to be displayed;
tracking a progress indication achieved for the given portion of the image.

19. The method of claim 11, further comprising:
receiving feedback from components downstream from the encoder indicating whether an image quality update is to be dropped by a downstream component;
implementing additional policies at downstream components based on factors comprising:
the first and second policies;
system constraints;
the feedback from downstream components; or
any combination thereof.

20. The method of claim 11, further comprising flagging encoded data based on a prioritization to be readable by downstream components.

21. A computer readable medium including code, when executed, to cause a processing device to:
provide image data to an encoder for transmission to a display;
provide an indication of whether at least a portion of the image data is video data or non-video data;
implement a first policy at the encoder prioritizing transmission of the image data over encoded image quality for image data that is non-video data; and
implement a second policy at the encoder prioritizing encoded image quality over transmission for image data that is non-video data.

22. The computer readable medium of claim 21, wherein the code, when executed, causes the processing device to implement the second policy when the portion of the image data is below a threshold of a total display area at which the image data is to be displayed.

23. The computer readable medium of claim 23, wherein the code, when executed, causes the processing device to implement the second policy by generating an intraframe (i-Frame) for transmission as opposed to an predictive frame (p-Frame) as long as the portion of the image data is below the threshold.

24. The computer readable medium of claim 22, wherein the code, when executed, causes the processing device to implement the second policy by providing an initial update having a maximum image quality in view of system constraints imposing a limit on maximum image quality encoding.

25. The computer readable medium of claim 24, wherein the code, when executed, causes the processing device to incrementally update encoded image quality until one or more of:
a target quality is achieved;
a change to the displayed image continues to occur before the target quality is achieved; and
system constraints impose a limit on subsequent updates.
